(19) United States
(12) Patent Application Publication
(10) Pub. No.: US 2006/0072042 A1
(43) Pub. Date: Apr. 6, 2006

(54) Video output apparatus and method thereof

(75) Inventors: Hsien Chun Chang, Keelung City (TW); Shiu Rong Tong, Kaohsiung City (TW); Jin Sheng Gong, Longtan Township (TW)

Correspondence Address: TROXELL LAW OFFICE PLLC;SUITE 1404, 5205 LEESBURG PIKE, FALLS CHURCH, VA, 22041, US

(73) Assignee: REALTEK SEMICONDUCTOR CORP.

(21) Appl. No.: 11/236,664

(22) Filed: Sep. 28, 2005

(30) Foreign Application Priority Data
Oct. 1, 2004 (TW) 093129767

(51) Int. Cl. H04N 9/64

(52) U.S. Cl. 348/714

(57) ABSTRACT

A video output apparatus and a method thereof, which can repeatedly output the last normally displayed frame during re-configuration of a display device, are disclosed. The video output apparatus receives a first and a second frames in order via an input, and determines either to output the first and second frames orderly or to output the first frame repeatedly according to a control signal.

### BACKGROUND OF THE INVENTION

(a). Field of the Invention

This invention is related to a display device, and especially, to a video output apparatus of the display device.

(b). Description of the Prior Arts

When a display such as a CRT or LCD display encounters some special condition (such as a change in operation status), the display will perform a re-configuration accordingly to adjust related operation settings so as to accurately process subsequent received frames. The examples of the special condition include: switching to a different input signal source, change of the input signal format, overflow/underflow of internal memory, interruption, etc. However, the re-configuration takes time, and the display may receive one or more frames during the course of re-configuration. Thus, the received frame will be displayed abnormally before the re-configuration is finished.

A known solution for this problem is to perform the re-configuration directly or to show error information with OSD (On-Screen Display) during the process of re-configuration, regardless of whether the received frame is displayed abnormally.

Another known method is using two sets of registers to store operation settings of the display. One set of registers stores the current settings. When the display performs a re-configuration, new operation settings are written to the other set of registers. After finishing the re-configuration (i.e. the new settings are available for use), the display switches to operate on the new settings. However, this known method not only costs more for hardware but fails to avoid the abnormal frame display during the re-configuration. For example, if the memory of the display underflows and the ensuing frames cannot resupply to the memory, the display still cannot operate normally even if the original settings are used.

### SUMMARY OF THE INVENTION

It is therefore one of objectives of this invention to provide a video output apparatus and a method thereof for a display device, thereby solving the above-mentioned problem.

According to an embodiment of this invention, a video output apparatus in a display device is disclosed. The apparatus comprises: an input terminal configured to receive a first frame and a second frame in order; and an output circuit, coupled to the input terminal, configured to determine either to output the first and second frames orderly or to output the first frame repeatedly according to a control signal.

According to another embodiment of this invention, a method for outputting a video signal for a display device is disclosed. The method comprises: receiving the video signal; temporarily storing the video signal into a buffer; outputting the video signal according to an order of reception when the display device operates in a first mode; and repeatedly outputting the video signal stored in the buffer when the display device operates in a second mode.

### BRIEF DESCRIPTION OF THE DRAWINGS

FIG. 1 is a block diagram of a video output apparatus according to the present invention.

FIG. 2 is a diagram showing how the output unit 12 of FIG. 1 outputs frames under normal and abnormal conditions.

FIG. 3A is a block diagram of the first embodiment of the video output apparatus according to this invention.

FIG. 3B is a block diagram of the second embodiment of the video output apparatus according to the present invention.

FIG. 3C is a block diagram of the third embodiment of the video output apparatus of this invention.

FIG. 4 is a block diagram of an embodiment of the output unit including an overdriving unit.

FIG. 5 is a block diagram of another embodiment of the output unit including the overdriving unit.

FIG. 6 is a flow chart of a preferred embodiment of the video output method according to this invention.

### DETAILED DESCRIPTION OF THE INVENTION

FIG. 1 is a block diagram of a video output apparatus 10 according to the present invention. The video output apparatus 10 is located in a display device (such as a CRT or LCD display), and includes an input terminal 11 and a coupled output unit 12. A video signal source 13 sends a plurality of frames in order through the input terminal 11 to the output unit 12. When the display device operates in a normal mode, the output unit 12 outputs these frames successively. When an “abnormal” condition happens, the display device will operate in a special mode and the output unit 12 will repeat the frame outputted most recently rather than output the next frame. Here, the abnormal condition indicates a change in operation status as mentioned above, and so the display device must perform a re-configuration. The output unit 12 knows the beginning and end of the abnormal condition according to a control signal.

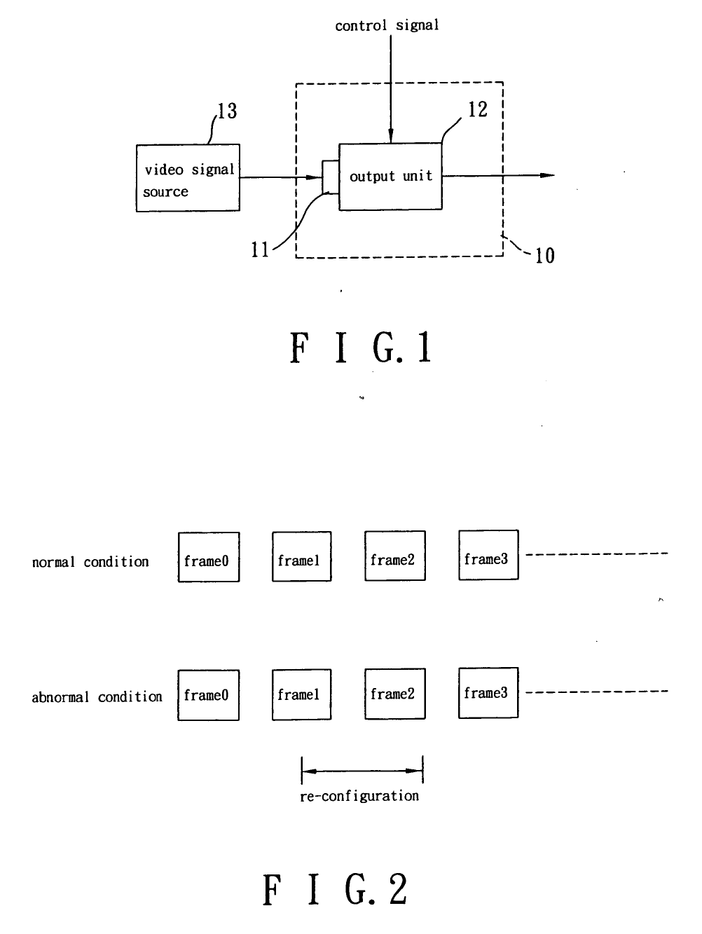

FIG. 2 is a diagram showing how the output unit 12 of FIG. 1 outputs frames under normal and abnormal conditions. In FIG. 2, under the normal condition, the output unit 12 outputs frame 0, frame 1, frame 2 and 3, etc. in sequence. However, if the re-configuration occurs before the video signal source 13 provides frame 2 (at this time, the output unit 12 is outputting frame 1), the output unit 12 will output frame 1 again rather than frame 2 as in the normal condition. If the re-configuration process is done (that is, the display goes to the normal condition) in the end of repeated frame 1, the frame 3 will be outputted consequently, as shown in FIG. 2. In FIG. 2, frame 1 is repeated only once since less time is taken up for the re-configuration. However, if the process takes a much longer time, the same frame will be outputted more than once, and this is controlled by the control signal of FIG. 1.

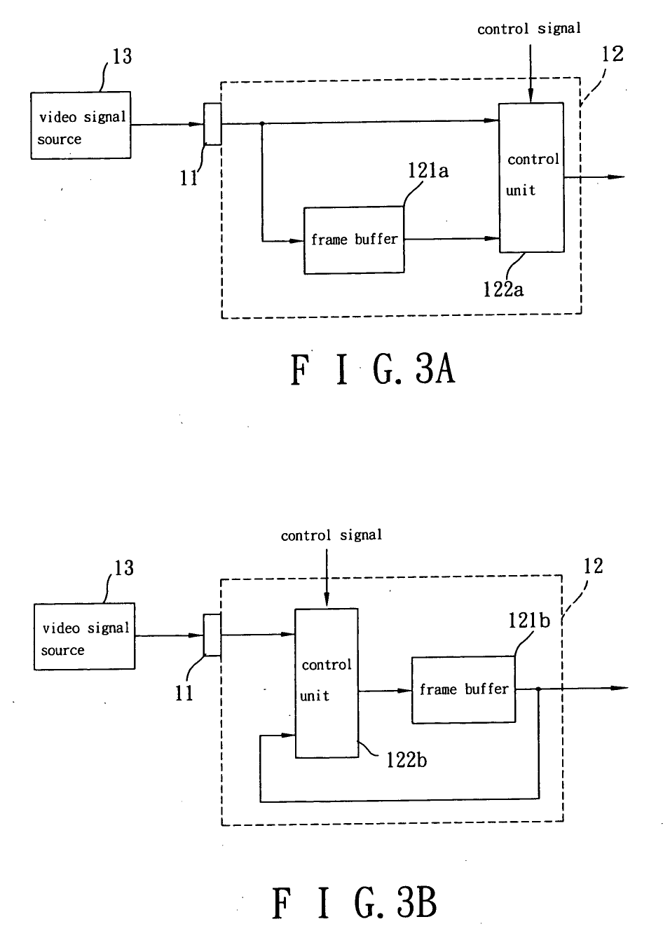

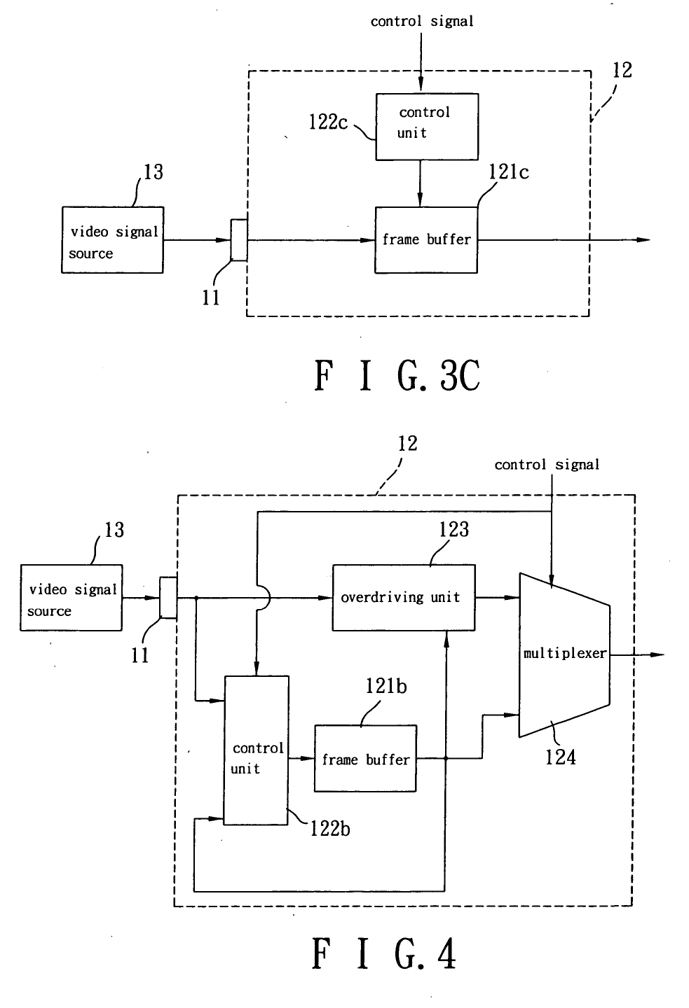

FIG. 3A is a block diagram of the first embodiment of the video output apparatus 10 according to this invention. In this embodiment, the output unit 12 includes a frame buffer 121a and a control unit 122a. Through the input terminal 11, the frame buffer 121a receives and stores one frame from the video signal source 13. The control unit 122a is coupled to the frame buffer 121a and the input terminal 11, and chooses either from the frame buffer 121a or the input terminal 11 to output the frame according to the control signal. Please refer to FIG. 2 again. Under the normal condition, the control unit 122a outputs frame 0 to frame 3 from the input terminal 11 successively. Meanwhile, these frames are stored into the frame buffer 121a to replace the previous stored frame. If an abnormal condition comes along before the video signal source 13 provides frame 2, the control signal will switch the control unit 122a to select the frame buffer 121a after frame 1 is outputted (and also stored into the frame buffer 121a). Then, the control unit 122a repeatedly outputs frame 1 stored in the frame buffer 121a. If the re-configuration process is accomplished as the repeated output of frame 1 ends, the control signal will switch the control unit 122a back to select the input terminal 11, and the following frame 3 will be outputted (and stored in the frame buffer 121a at the same time). In this embodiment, the control unit 122a serves as a multiplexer.

FIG. 3B is a block diagram of the second embodiment of the video output apparatus 10 according to the present invention. In this embodiment, the output unit 12 includes a frame buffer 121b and a control unit 122b. The frame buffer 121b receives one frame from an output terminal of the control unit 122b and stores it. Two input terminals of the control unit 122b are coupled to the input terminal 11 and the frame buffer 121b, respectively. According to the control signal, the control unit 122b selects either the input terminal 11 or the frame buffer 121b for outputting. Please again refer to FIG. 2. Under the normal condition, the control unit 122b selects the input terminal 11, and the video signal source 13 transmits frame 0 to frame 3 successively to the frame buffer 121b via the input terminal 11 and the control unit 122b. Meanwhile, the frame buffer 121b also outputs its stored frames successively. That is, when frame 1 is stored into the frame buffer 121b, frame 0 is outputted from the frame buffer 121b concomitantly, and so on. If an abnormal condition occurs before the video signal source 13 provides frame 2, the control signal will switch the control unit 122b to select the frame buffer 121b after frame 1 is stored in the frame buffer 121b. In this way, frame 1 is outputted from and written back into the buffer 121b simultaneously. When the re-configuration is done, the control unit 122b is switched back to select the input terminal 11 to transmit frame 3 provided by the video signal source 13 to the frame buffer 121b. During this same time, the frame buffer 121b outputs the stored frame 1, that is, frame 1 is repeated. Then, the frame buffer 121b recovers to the normal condition and outputs the stored frame 3. In this embodiment, the control unit 122b serves as a multiplexer.

FIG. 3C is a block diagram of the third embodiment of the video output apparatus 10 of this invention. In this embodiment, the output unit 12 includes a control unit 122c and a coupled frame buffer 121c. The control unit 122c is capable of altering the input/output (I/O) mechanism of the frame buffer 121c according to a control signal. As a special condition of the display device is detected (that is, when the control signal is enabled), new video signal is stopped from being written to the frame buffer 121c and the frame buffer 121c automatically outputs its stored video signal repeatedly. An embodiment of the control unit 122c is a direct memory access (DMA) logic.

In another embodiment, the video output apparatus 10 further includes a detector (not shown) for detecting the operation mode of the display device and outputting a control signal correspondingly.

In the display device, the frame buffers 121a, 121b and 121c shown in FIG. 3A, 3B and 3C are independent from the data processing function related to the re-configuration process. Thus, what these buffers store will not be affected when the display device undergoes the re-configuration process. In this manner, when the re-configuration is performed, the frame buffers 121a, 121b and 121c are capable of outputting the frames stored before the re-configuration without any influence from the modification of related set values.

Besides, the frame buffers 121a, 121b and 121c are capable of storing other information without affecting the function of maintaining normal display under an abnormal condition, or they could be accessed by other functional blocks of the display device, such as a microcontroller (MCU). In one embodiment, the frame buffers 121a, 121b and 121c store a start frame of the display device during the start process. In another embodiment, as the frame buffers 121a, 121b and 121c are executing a multi-picture output function (such as the often seen picture-in-picture) for the display device, not all the frames but the ones affected during the re-configuration are stored to economize the space of the buffer. In still another embodiment, each of the frame buffers 121a, 121b and 121c comprises a first storage space and a second storage space. The second storage space of each buffer is accessed by the corresponding control unit, while the first storage space is accessed by an other functional block of the display device.

The output unit 12 of FIG. 1 can include other functional blocks of the display device not involved in the re-configuration process, such as an overdrive circuit, OSD circuit, etc., to share the space of the internal buffers so that the hardware cost can be economized. FIG. 4 is a block diagram of an embodiment of the output unit 12 including an overdriving unit 123. The overdriving technique enables the display device to output a frame with more (or less) intensity than predetermined, by means of comparing the output parameter values (such as brightness in pixel) of the frame and a preceding frame. In this way, the response time of the display device (such as a LCD) is improved. In FIG. 4, the output unit 12 includes the embodiment shown in FIG. 3B, the overdriving unit 123 and a multiplexer 124. The overdriving unit 123 receives a first frame from the input terminal 11 and a second frame from the frame buffer 121b respectively. According to the result of a comparison between the first and second frames, the overdriving unit 123 overdrives the second frame and transmits it to the multiplexer 124. The multiplexer 124 and control unit 122b are controlled by the same control signal. The multiplexer 124 selects either the frame buffer 121b or the overdriving unit 123 for outputting according to the control signal.

In the embodiment shown in FIG. 4, when the display device is under the normal condition, the multiplexer 124 chooses the overdriving unit 123 according to the control signal for outputting an overdriven frame, and the control unit 122b selects the input terminal 11 to transmit a next frame provided by the video signal source 13 into the frame buffer 121b. Compared with FIG. 3B, the output unit 12 in FIG. 4, when under the normal condition, will overdrive the frames provided orderly by the video signal source 13 before outputting them. When the display device is in an abnormal condition, the control unit 122b stops storing a new frame into the buffer 121b according to the control signal, and the multiplexer 124 selects the frame buffer 121b to output a previously stored frame according to the control signal. During this time, the output unit 12 functions as that in FIG. 3B.

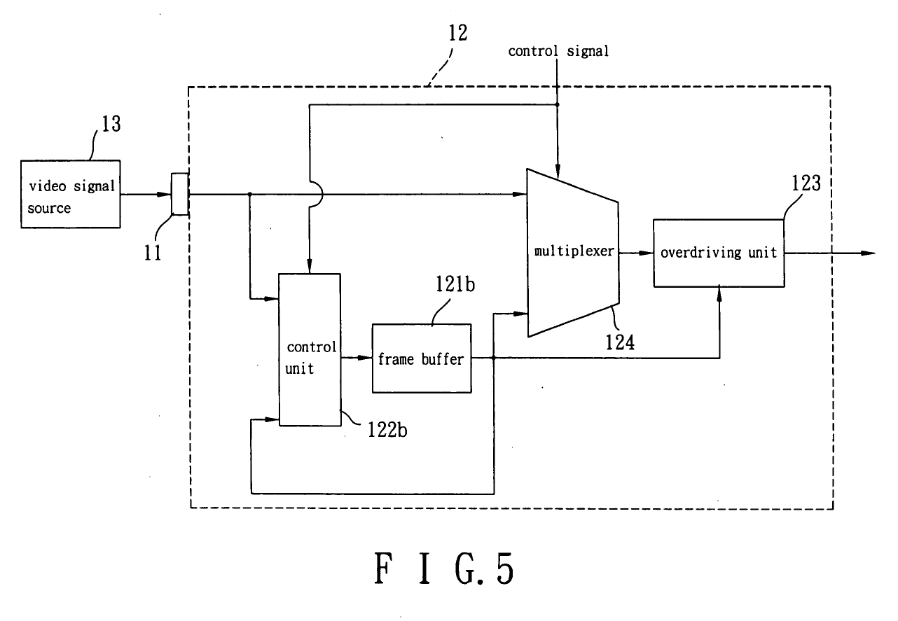

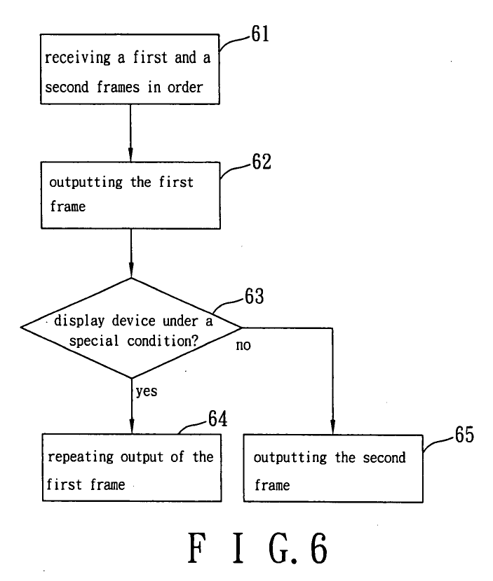

FIG. 5 is a block diagram of another embodiment of the output unit 12 including the overdriving unit 123. In this embodiment, the overdriving unit 123 is coupled to the output terminal of the multiplexer 124. In the normal condition, the multiplexer 124 selects the input terminal 11 according to the control signal and transmits a frame to the overdriving unit 123, which receives a previous frame from the frame buffer 121b and overdrives the received frame; the control unit 122b operates as that in FIG. 4. In the abnormal condition, the multiplexer 124 selects the frame buffer 121b to output a stored frame and at the same time, the overdriving unit 123 receives the same stored frame from the buffer 121b. Then, the overdriving unit 123 will output the received frame as it is since the two frames to be compared are the same. Thus, the embodiment shown in FIG. 5 operates equivalently with that shown in FIG. 4.

However, the embodiments shown in FIGS. 4 and 5 are just two examples showing how the output unit 12 shares the space of the buffer with another functional block of the display device. The application of this invention is not limited thereto. In general, the output unit 12 in FIG. 1 is capable of sharing the buffer with any functional block which is not affected by the re-configuration process, thereby saving hardware cost.

FIG. 6 is a flow chart of a preferred embodiment of the video output method according to this invention. The method is used in a display device. As shown in FIG. 6, the flow includes the steps of:
61 receiving a first and a second frames in order;
62 outputting the first frame;
63 determining if the display device is under a special condition, wherein if yes, go to the next step; if not, skip to step 65;
64 repeating output of the first frame, and ending the flow; and
65 outputting the second frame.

Step 63 is executed based on a control signal. If the display is under the special condition (e.g. an abnormal condition causing the display to perform a re-configuration) or operates in a special mode, the first frame is repeatedly outputted (step 64); if the display is under a normal condition or operates in a normal mode, then the display outputs the second frame (step 65). It is notable that the flow of FIG. 6 can be extended to output a plurality of frames because any two successive frames can be processed in the same way as described above.

In a varied embodiment of FIG. 6, if the display device needs a longer time for re-configuration, the first frame can be outputted again and again (i.e. step 64 is repeated several times) according to the determining results of step 63. As the re-configuration process ends, the display recovers to the normal condition, and step 65 is adjusted to output a third frame provided first after the reconfiguration process rather than output the second frame.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A video output apparatus for a display device comprising:
an input terminal configured to receive a video signal;
a buffer configured to temporarily store the video signal; and
a control circuit, coupled to the buffer, configured to output the video signal received by the input terminal;
wherein the control circuit outputs the video signal according to an order of reception when the display device operates in a first mode;
wherein the control circuit repeatedly outputs the video signal stored in the buffer when the display device operates in a second mode.

2. The apparatus of claim 1, wherein the first and the second modes are a normal mode and a special mode, respectively.

3. The apparatus of claim 2, wherein the special mode comprises a re-configuration condition.

4. The apparatus of claim 2, wherein the special mode comprises an input signal switching condition, a format changing condition, a buffer overflow condition, a buffer underflow condition, an interrupt condition, or a re-configuration condition.

5. The apparatus of claim 3, further comprising:
a functional block, coupled to the buffer, wherein the functional block and the control circuit share storage space of the buffer.

6. The apparatus of claim 3, further comprising:
a functional block, coupled to the buffer, wherein the buffer comprises a first storage space and a second storage space, the functional block and the control circuit access the first and the second spaces of the buffer, respectively.

7. The apparatus of claim 5, wherein the functional block comprises an overdrive circuit for overdriving the video signal to output an overdriven video signal.

8. The apparatus of claim 7, wherein the overdrive circuit is configured to selectively output either the overdriven video signal or the original video signal according to the operation mode of the display device.

9. The apparatus of claim 3, wherein the frame buffer further stores a start frame of the display device.

10. The apparatus of claim 3, wherein the control circuit comprises:
a detector configured to determine whether the display device operates in the first mode or in the second mode.

11. The apparatus of claim 1, wherein the control circuit comprises:
a detector configured to determine whether the display device operates in the first mode or in the second mode.

12. A method for outputting a video signal for a display device, comprising:
receiving the video signal;
temporarily storing the video signal into a buffer;
outputting the video signal according to an order of reception when the display device operates in a first mode; and
repeatedly outputting the video signal stored in the buffer when the display device operates in a second mode.

13. The method of claim 12, wherein the first and the second modes are a normal mode and a special mode, respectively.

14. The method of claim 13, wherein the special mode comprises a re-configuration condition.

15. The method of claim 13, wherein the special mode comprises an input signal switching condition, a format changing condition, a buffer overflow condition, a buffer underflow condition, an interrupt condition, or a re-configuration condition.

16. The method of claim 12, further comprising:
overdriving the video signal.

17. A video output apparatus for a display device comprising:
an input terminal configured to receive a video signal;
a buffer configured to temporarily store the video signal; and
a control circuit, coupled to the buffer, configured to control input/output (I/O) of the buffer according to an operation mode of the display device.

18. The apparatus of claim 17, wherein the control circuit comprises a direct memory access (DMA) logic.

19. The apparatus of claim 18, wherein the control circuit comprises:
a detector configured to detect the operation mode of the display device.

20. The apparatus of claim 18, wherein the control circuit repeatedly outputs the video signal stored in the buffer when the display device operates in a re-configuration mode.
